(19) United States
(12) Patent Application Publication
(10) Pub. No.: US 2023/0068457 A1
(43) Pub. Date: Mar. 2, 2023

(54) BOWL WHICH CAN BE ADSORBED ON THE TABLE TOP

(71) Applicant: Shenzhen Helpcook Technology Co., Ltd., Shenzhen (CN)

(72) Inventor: Xiujun Wu, Shenzhen (CN)

(21) Appl. No.: 17/650,665

(22) Filed: Feb. 11, 2022

(30) Foreign Application Priority Data
Sep. 2, 2021 (CN) 202122117494.X

(51) Int. Cl. A47G 19/10; A47G 19/12; F16B 47/00

(52) U.S. Cl. CPC A47G 19/10; A47G 19/12; F16B 47/00

(57) ABSTRACT

The is a bowl which can be adsorbed on the table top, has a bowl body, a notch is opened at the bottom of the bowl body, a silicone suction cup is arranged in the notch, and the silicone suction cup is protrudes downward of the bowl body by a predetermined length, the silicone suction cup is used for adsorbing the table top, and the bottom of the bowl body abuts on the table top. The bottom of the bowl body abuts against the table top closely, so that the gap between the bowl body and the silicone suction cup is hidden in the notch, and the user cannot touch the silicone suction cup, and the fingers cannot be inserted into the gap between the bowl body and the silicone suction cup, it improves the adsorption stability of the bowl. the whole bowl will not shake and has high stability.

### CROSS-REFERENCE TO RELATED APPLICATIONS

This application claims priority to Chinese Patent Application No. 202122117494.X, filed on Sep. 2, 2021, the contents of which are herein incorporated by reference in their entireties.

### TECHNICAL FIELD

The present disclosure relates to tableware, and in particular to a bowl which can be adsorbed on the table top.

### BACKGROUND

In the prior art, in order to fix the bowl on the table top, desktop and so on, a silicone suction cup that can be adsorbed on the table top is generally arranged at the bottom of the bowl. This type of product is usually used as a children's bowl, and its purpose is to prevent children from being knocked over their bowls during the meal. Please refer to the Chinese patent application with the publication number CN204427465U and the title “a suction cup bowl”, this type of product is to directly expose the silicone suction cup at the bottom of the bowl. Between the back of the silicone suction cup and the outer side wall of the bowl, an obvious gap will be formed, and children often put their fingers into the gap when eating. In this case, the silicone suction cup is easily deformed, which will be separated from the table, resulting in poor adsorption stability. In addition, the structure of the exposed silicone suction cup is also easy to fall off when the silicone suction cup is touched, so it cannot meet the high reliability requirements.

### SUMMARY

The technical problem to be solved by the present disclosure is to provide a bowl which can hide the gap between the bowl body and the silicone suction cup and help to improve the adsorption stability between the silicone suction cup and the table top, aiming at the deficiencies of the prior art.

In order to solve the technical problem mentioned above, the present disclosure adopts the following technical solutions.

A bowl which can be adsorbed on the table top, comprising a bowl body, a notch is opened at the bottom of the bowl body, a silicone suction cup is arranged in the notch, and the silicone suction cup protrudes downward of the bowl body by a predetermined length, the silicone suction cup is used for adsorbing the table top, and the bottom of the bowl body abuts against the table top.

Wherein, a pull tab protruding outward is formed at the edge of the silicone suction cup.

Wherein, an escape opening is opened at the bottom edge of the bowl body, and the pull tab is located in the escape opening.

Wherein, the bowl body is a silicone bowl body, and the bowl body and the silicone suction cup are integrally formed.

Wherein, the bowl body is a circular bowl, and the notch is a circular notch.

Wherein, an annular surface for abutting against the table top is formed at the edge of the notch.

For the bowl that can be adsorb on the table top disclosed in the present disclosure, a notch for accommodating the silicone suction cup is provided at the bottom of the bowl body, and at the same time, the silicone suction cup is made to protrude below the notch. When the bowl is placed on the table top, under the action of gravity, the silicone suction cup and the table top are vacuum-adsorbed. And at the same time, the silicone suction cup is deformed, and its edge part tends to be flat along the table top, so as to be accommodated in the notch. This matching relationship makes the bottom of the bowl body abutted against the table top, so that the gap between the bowl body and the silicone suction cup is hidden in the notch, and children cannot touch the silicone suction cup when eating, and the fingers cannot be inserted into the gap between the bowl body and the silicone suction cup, so the adsorption stability of the bowl is greatly improved. In addition, because the silicone suction cup is hidden in the notch, the whole bowl will not shake, which better meets the application requirements of high stability.

### BRIEF DESCRIPTION OF THE DRAWINGS

FIG. 1 is a stereogram 1 of the present disclosure.

FIG. 2 is a stereogram 2 of the present disclosure.

FIG. 3 is a stereogram 3 of the present disclosure.

FIG. 4 is a lateral view 1 of the present disclosure.

FIG. 5 is a lateral view 2 of the present disclosure.

FIG. 6 is a cross-sectional view taken along line A-A in FIG. 5.

FIG. 7 is an overhead view of the present disclosure.

FIG. 8 is a cross-sectional view taken along line B-B in FIG. 7.

### DETAILED DESCRIPTION

The present disclosure will be described in more detail in connection with the drawings and embodiments.

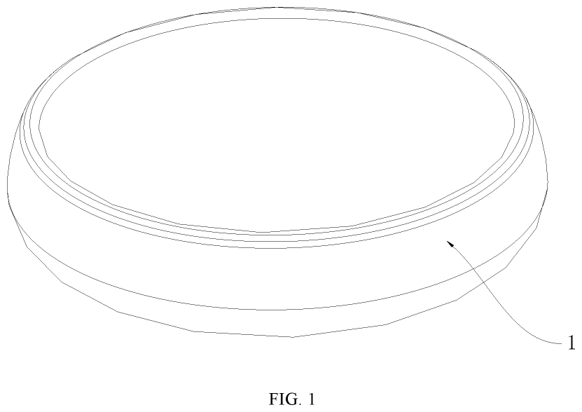

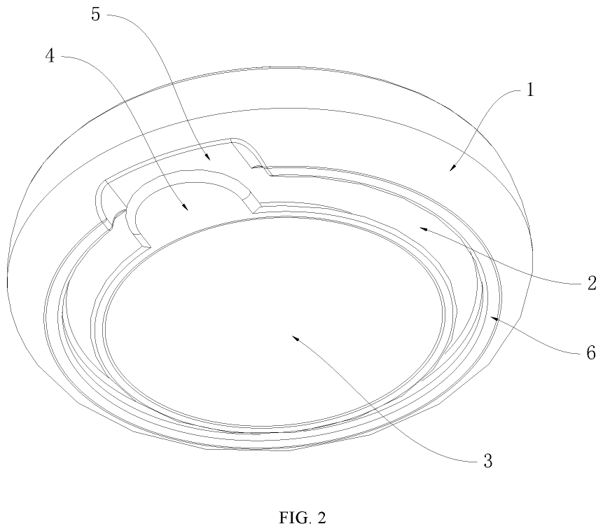

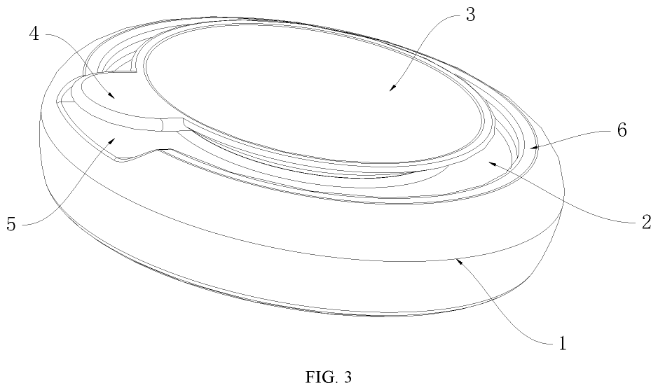

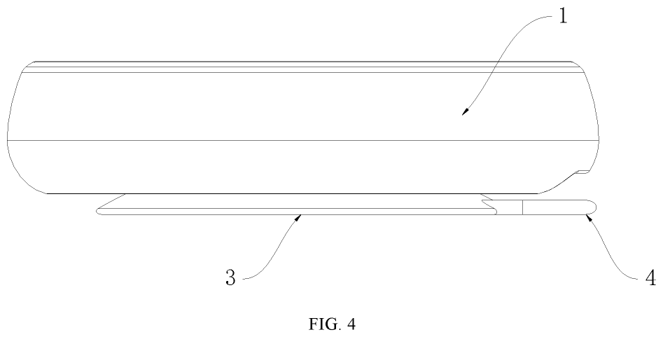

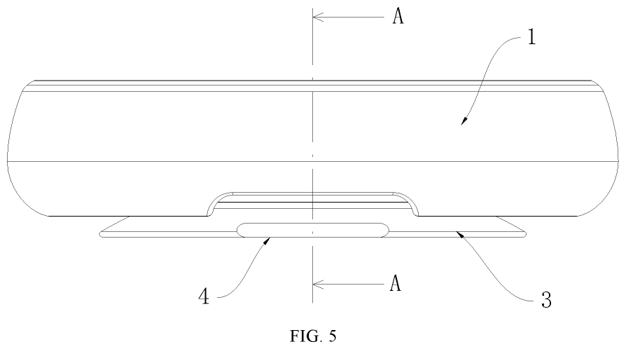

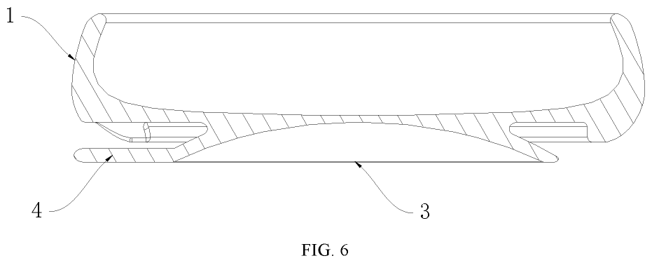

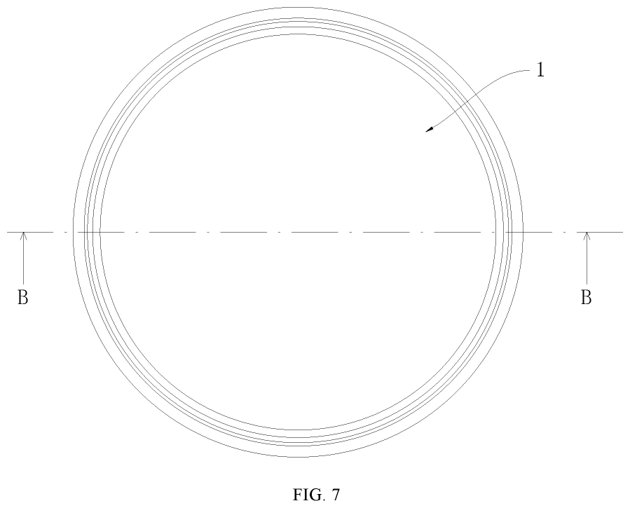

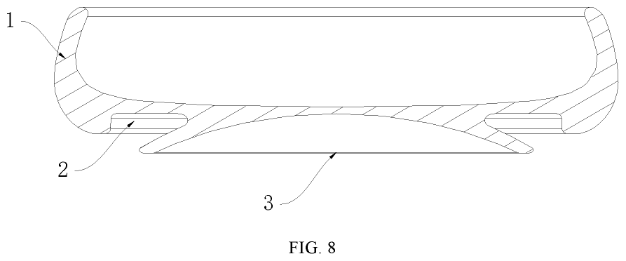

The present disclosure discloses a bowl which can be adsorbed on the table top. As shown in FIG. 1 to FIG. 8, it comprises a bowl body 1, a notch 2 is opened at the bottom of the bowl body 1, and a Silicone suction cup 3 is arranged in the notch 2, the silicone suction cup 3 protrudes below the bowl body 1 by a predetermined length, the silicone suction cup 3 is used for adsorbing the table top, and the bottom of the bowl body 1 abuts against the table top.

In the above structure, the bottom of the bowl body 1 is provided with a notch 2 for accommodating the silicone suction cup 3, and at the same time, the silicone suction cup 3 is made to protrude below the notch 2, when the bowl is placed on the table top, under the action of gravity, the silicone suction cup 3 is vacuum-adsorbed with the table top, and at the same time the table top suction cup 3 is deformed, and its edge part tends to be flat along the table top, so as to be accommodated in the notch 2, This matching relationship makes the bottom of the bowl body 1 abutting against the table top, thereby hiding the gap between the bowl body 1 and the silicone suction cup 3 in the notch 2, and children cannot touch the silicone suction cup 3 when eating, and the fingers cannot be inserted into the gap between the bowl body 1 and the silicone suction cup 3, so the adsorption stability of the bowl is greatly improved, and it better meets the application requirements of high stability.

In practical application, the silicone suction cup 3 slightly protrudes below the bowl body 1, and the specific degree of protrusion only needs to meet the requirement that the bottom of the bowl body 1 and the table top can be kept in abutting against each other. In addition, the downward protruding degree of the silicone suction cup 3 can also be designed according to the size and weight of the bowl body 1.

In order to facilitate the removal of the adsorption force of the silicone suction cup 3, in this embodiment, a pull tab 4 protruding outward is formed at the edge of the silicone suction cup 3.

Further, an escape opening 5 is opened at the bottom edge of the bowl body 1, and the pull tab 4 is located in the escape opening 5. The escape opening 5 helps the user to pull the pull tab 4.

In this embodiment, the bowl body 1 is a silicone bowl body, and the bowl body 1 and the silicone suction cup 3 are integrally formed. However, this is only a preferred embodiment of the present disclosure, and is not intended to limit the present disclosure. According to actual needs, the bowl body 1 can also be made into a ceramic bowl or a plastic bowl, and then fixed connect with the silicone suction cup 3. However, no matter which structure is adopted, all belong to the equivalent structure of the present disclosure, and therefore all belong to the protection scope of the present disclosure.

In this embodiment, the bowl body 1 is a circular bowl, and the notch 2 is a circular notch.

As a preferred manner, an annular surface 6 for abutting against the table top is formed at the edge of the notch 2. In the above structure, by arranging the annular surface 6, the bottom of the bowl body 1 and the table top can be reliably and closely abut with each other, thereby improving the adsorption stability of the bowl and the table top.

The above are only preferred embodiments of the present disclosure and are not intended to limit the present disclosure. Any modifications, equivalent replacements or improvements made within the technical scope of the present disclosure shall be included in the protection range of the present disclosure.

1. A bowl which can be adsorbed on a table top, comprising a bowl body, a notch opened at the bottom of the bowl body, a silicone suction cup arranged in the notch, wherein the silicone suction cup protrudes downward of the bowl body by a predetermined length, the silicone suction cup is used for adsorbing the table top, the silicone suction cup is deformed, and its edge part tends to be flat along the table top, so as to be accommodated in the notch, and the matching relationship between the silicone suction cup and the notch makes the bottom of the bowl body abuts against the table top, thereby hiding the gap between the bowl body and the silicone suction cup in the notch.

2. The bowl which can be adsorbed on the table top according to claim 1, wherein a pull tab protruding outward is formed at an edge of the silicone suction cup.

3. The bowl which can be adsorbed on the table top according to claim 2, wherein an escape opening is opened at a bottom edge of the bowl body, and the pull tab is located in the escape opening.

4. The bowl which can be adsorbed on the table top according to claim 1, wherein the bowl body is a silicone bowl body, and the bowl body and the silicone suction cup are integrally formed.

5. The bowl which can be adsorbed on the table top according to claim 1, wherein the bowl body is a circular bowl, and the notch is a circular notch.

6. The bowl which can be adsorbed on the table top according to claim 1, wherein an annular surface for abutting against the table top is formed at the edge of the notch.
